(19) United States
(12) Patent Application Publication
(10) Pub. No.: US 2002/0084028 A1
(43) Pub. Date: Jul. 4, 2002

(54) Process for tempering plastic films to be bonded and device for bonding plastic films with temperature controlled transport roll

(76) Inventor: Thomas Knoke, Bielefeld (DE)

Correspondence Address: JACOBSON HOLMAN PLLC, 400 SEVENTH STREET N.W., SUITE 600, WASHINGTON, DC, 20004, US

(21) Appl. No.: 10/012,355

(22) Filed: Dec. 12, 2001

(30) Foreign Application Priority Data
Dec. 12, 2000 (DE) 100 61 804.9
Jan. 31, 2001 (DE) 101 04 002.4

(51) Int. Cl. C09J 1/00

(52) U.S. Cl. 156/281; 156/285

(57) ABSTRACT

Process for setting the temperature of plastic film, which is to be bonded and which exists preferably in the form of slips (8), on collapsed tubular pieces or workpieces (2) made of plastic film, for example valve slips on the raised bottom squares, or bottom cover sheets on the assembled bottoms of block bottom valve sacks,

whereby the tubular pieces or the workpieces are conveyed by means of a conveyor with a plate or a table (1) and fed into a slit between a counterpressure element, preferably a counterpressure roll (4) and a suction cylinder (6), and

whereby the plastic film to be bonded is fed and transferred by a conveying cylinder (7) to the suction cylinder (6),

whereby the plastic film to be bonded is already heated in the roll slit during transport.

Furthermore, a device is presented for carrying out the process that exhibits a heatable conveying roll.

The invention relates to a process for tempering plastic films in accordance with the preamble of claim 1 and a device for bonding plastic slips in accordance with the preamble of claim 9.

Processes and devices for bonding plastic films on tubular pieces or workpieces, which are also often made of plastic film, are known from the literature. When several thermoplastic elements are bonded together, it is often practical to heat these elements and thus to etch at least their surface.

In this respect the term bond combines several different methods of joining plastic films, whereby the process temperature is a factor. Usually, as stated above, the surface of the plastic film is plasticized or melted by heating and then bonded or welded under pressure.

However, the term bonding is also defined by the classical term cementing, where another substance—which can be an adhesive—is applied additionally on one or both films. This substance can be an adhesive, which is initially liquid and then hardens. The third substance can also be tempered—optionally together with the film surfaces—and raised to a temperature that is appropriate for bonding. In this case, too, the two films are finally joined together under pressure.

According to the past state of the art, slips and workpieces are brought together in a roll slit. The contact surfaces of the elements to be bonded are heated inside the roll slit with hot air.

To obtain reliably repeatable results, the DE 198 18 720 shows a device, where the temperature of the already bonded elements is measured as the actual value after passage through the roll slit. The temperature of the hot air stream is adjusted according to this actual value.

However, setting the bonding temperature only by means of a suitable air stream has drawbacks. Thus, it takes sometimes several hours until the device modules adjacent to the roll slit have reached the working temperature. Therefore, the film is not exposed to the temperature effect of the air stream until in the immediate environment of the roll slit. Therefore, it is necessary to reduce the film's speed of passage through the roll slit during the run-in phase so that the film assumes the desired temperature.

The object of the present invention is to shorten this run-in phase so that the device can work faster at high speed. The invention solves the problem in that the plastic film is already tempered before reaching the roll slit.

This process can be carried out by tempering those parts of the conveyor that transport the plastic film to be bonded into the roll slit and by setting in this manner the temperature of the film.

The tempering can be limited, for example, to a conveying roll, but it can also be performed on the vacuum roll, or conveying and storage elements, positioned upstream in the conveying roll's processing direction, or on deflecting rolls or groups of belts, which interact with the conveying roll. Even a combination of the tempering of the aforementioned elements is conceivable. Even an integration of additional temperable elements, which fulfill neither a transport nor a storage function, but make mechanical contact with the film to be bonded during transport or storage, is possible. All of these possibilities are included in the phrase “devices that transport or store the film” in the characterizing part of claim 2.

The advantages of the invention include, besides the aforementioned shortening of the run-in phase, also a more efficient use of the supplied energy, since the air used in the past represents a relatively expensive form of thermal energy transfer.

The process of the invention can be combined with other processes for setting a suitable melting or bonding temperature, such as the aforementioned heating of the film in the roll slit by means of hot air or the heating of the workpieces in front of the roll slit.

Since the use of different heatable elements, the accumulation of the heat of friction or the process heat, and the ambient temperature can result in the necessity to cool, instead of heat, this application uses the word “tempering”, which includes both heating and cooling.

Temperature transfer from a conveying roll, made of cast material, to the plastic film, has proved to be especially appropriate, since this type of roll has a high thermal capacity. Hence, it exhibits a thermal inertia that is advantageous for a stable process, and in addition, makes relatively long contact with the film to be bonded.

Other advantages and advantageous embodiments of the invention follow from the other claims and the following description of the subject matter.

Embodiments of the invention are explained in detail below with reference to the drawings.

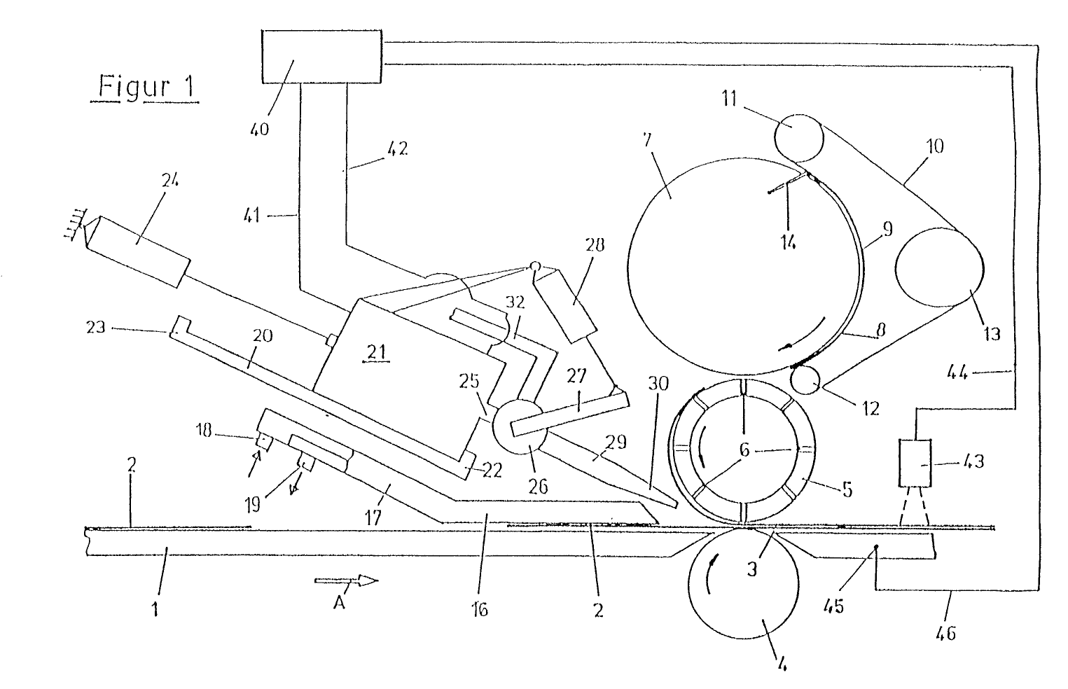

FIG. 1 is a schematic drawing of a side view of a device for applying and bonding slips on workpieces and additional hot air is blown into the roll slit.

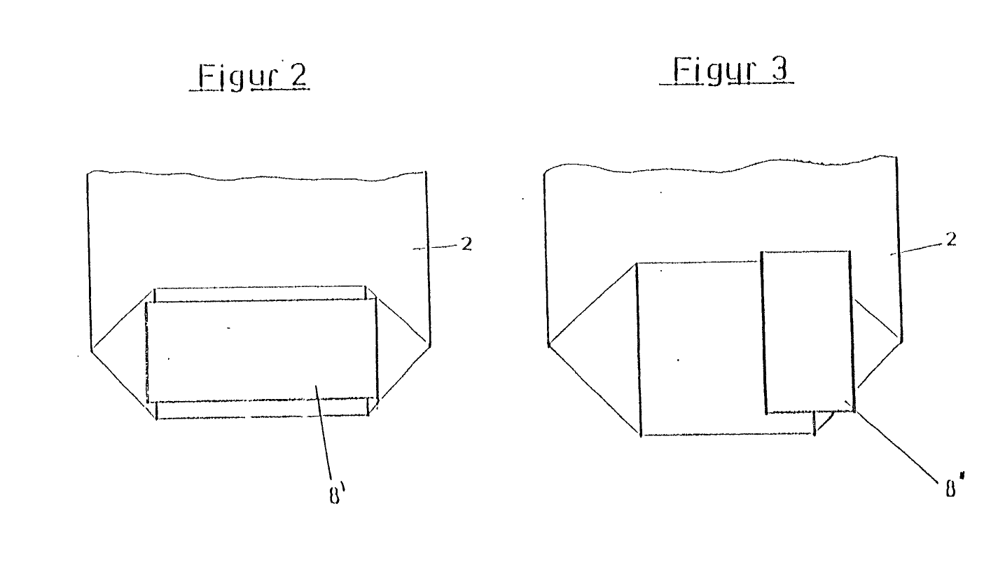

FIG. 2 is a top view of an assembled block bottom with cover sheet cemented on the bottom.

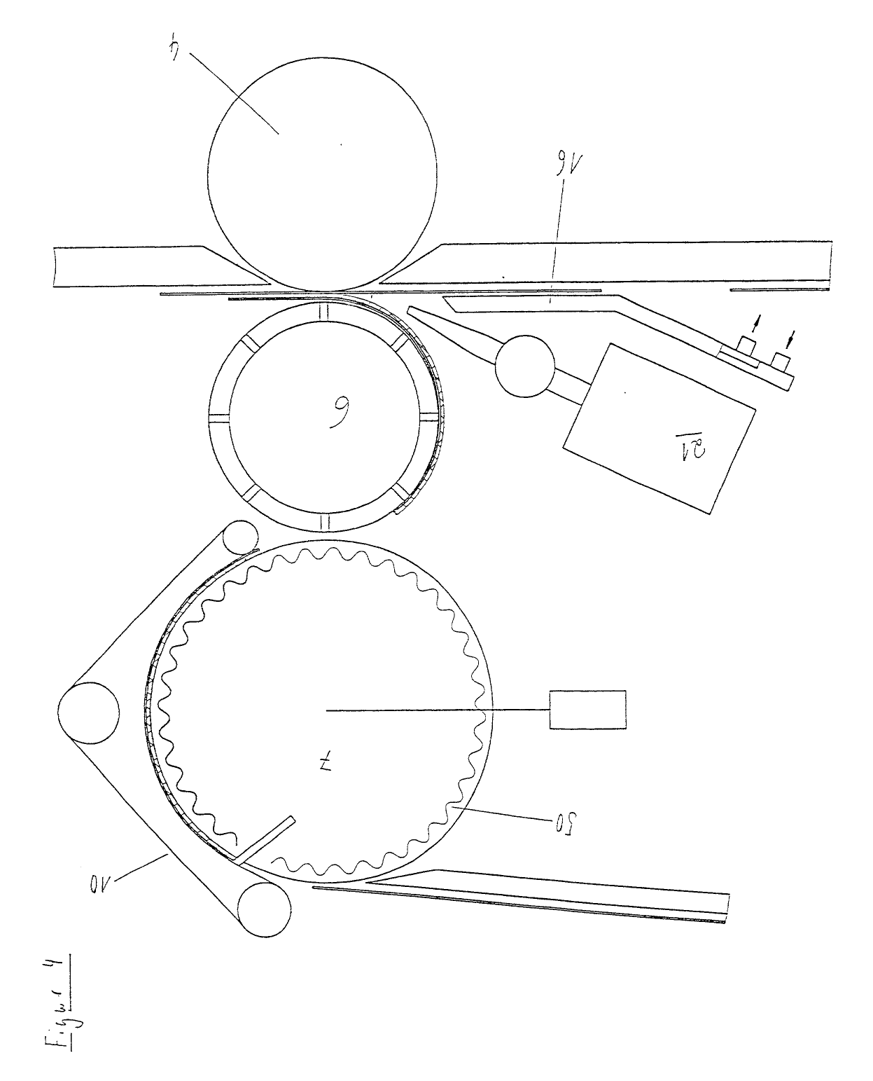

FIG. 3 is a raised bottom with a valve slip cemented on a corner fold.

FIG. 4 is a detail of a side view as in FIG. 1, where an additional heating coil is drawn in the transport cylinder.

A frame, which is not illustrated, holds a table plate 1, on which tubular pieces made of plastic, which are collapsed continuously in the direction of the A arrow and exhibit raised or assembled bottoms, are conveyed by means of conveyors, which are not illustrated. In the case of the tubular pieces 2, conveyed so as to lie transversely at an equidistance from each other, the assembled bottoms or the raised bottoms are folded in the plane of the collapsed tubular pieces, as shown in FIGS. 2 and 3. In the machine frame a counterpressure roll 4 and a suction roll 5, which form together a pair of conveying rolls and whose roll slit lies in the area of the plane of the top side of the table 1, are mounted in a transverse slit 3 of the table 1. The jacket of the suction cylinder 5 is provided with rows of suction air holes 6 at approximately equal angular distances. The suction air is withdrawn in the usual manner from the interior of the suction cylinder 6 through the rotary passage, which is not illustrated.

A knife and conveying cylinder 7 is mounted above the suction cylinder 5 in the machine frame. The slips 8, severed from the endless web of plastic (not illustrated), are pressed against said knife and conveying cylinder by means of a belt 9 of a continuous group of belts 10, which run over deflecting rolls 11, 12, 13, which are mounted above the machine frame and of which the roll 13 can also be driven. The knife and conveying cylinder 7 is provided in the usual manner with a knife 14, running along a surface line.

A plate 16, which serves to temper and thus set the appropriate temperature of the tubular pieces 2, ends in front of the roll slit of the pair of cylinders 4, 5. To this end, this plate can lead thermal energy to or away from the tubular pieces. However, this plate is hereinafter referred to as the cooling plate 16 for the sake of simplicity. This cooling plate 16 is provided with an inlet side 17, which is bent upwards. The cooling plate 16, 17 is provided with pipes, which are intended for a coolant or heating medium and exhibit a meandering and/or serpentine shape. A medium flows through said pipes. This medium, for example water, is passed through the hose lines (not illustrated) into the connecting piece 18 and withdrawn again out of the connecting discharge piece 19. An inclined guide 20, on which a heating unit 21 can be moved back and forth between the stops 22, 23 of the guide 20 by means of a pressure medium piston cylinder unit 24, is mounted above the cooling plate 16, 17 in the machine frame. The front end of the heating unit is provided with a pipe 25 for blowing out the hot air. The pipe 25 exhibits a rotary slide valve 26, whose slide valve can be moved into an open and closed position as well as intermediate positions, by means of an actuating lever 27. To actuate the lever 27, there is a pressure medium piston cylinder unit 28, which is hinged, on the one hand, to the hot air unit 21 and, on the other hand, to the actuating lever 27. One outlet of the rotary slide valve 26 opens into a pipe 29, which bears a slit die 30, which is aimed at the slit between the rolls 4, 5. The other outlet of the rotary slide valve 26 opens into a pipe 32, which opens into the open air or withdraws the hot air.

The suction cylinder 5 accepts the slips 8 in the illustrated manner from the knife and conveying cylinder 7 and puts them in the correct position on the sack workpieces travelling through. At the same time hot air is blown at controlled times through the slit die 30 into the roll slit, in which the slip 8 and the workpiece 2 are located. Said hot air plasticizes or melts the plastic material in such a manner that the slips 8 bond to the workpieces 2.

The hot air feed is time-controlled by means of a control unit by way of the pressure medium piston cylinder unit 28. Furthermore, the distance between the slit die 30 and the roll slit can be set, as desired, by means of the pressure medium piston cylinder unit 24.

In the embodiments, shown in FIGS. 1 to 4, not only the hot air feed but also the temperature of the suction cylinder 6, the conveying cylinder 7 and the cooling plate 16 can be regulated. In the case of extreme applications, it can even be necessary to blow cold air, instead of hot air, into the roll slit. The volume of air blown in per unit time is another parameter for setting the temperature.

FIG. 2 depicts a workpiece, which consists of an assembled block bottom, on which is cemented a bottom slip 8′.

FIG. 3 depicts a sack workpiece 2 with the bottoms, which are still open and where the valve slip 8″ is cemented on the leading corner fold of one bottom. This valve slip yields a valve tube when the side folds are folded in the well-known manner.

The device, depicted in FIG. 1, is provided twice on both sides of the table 1, when both bottoms, molded to the tubular pieces 2, are to be provided simultaneously with bottom cover sheets 8′.

Directly behind the pair of rolls, comprising the counterpressure roll 4 and the suction roll 5, the temperature of the bonded area of the tubular pieces 2 is measured by means of a temperature probe, in the illustrated embodiment by means of an infrared pyrometer 43, which is mounted in the machine frame at a predetermined distance above the workpieces passing out.

The measurement signals of the temperature probe 43 are sent over a signal line 44 to the control and regulating unit 40.

In this embodiment this control and regulating unit regulates the temperature of the rolls 6 and 7 and the cooling plate 16 over signal lines (not illustrated) and by means of heating and cooling elements (not illustrated).

Only the control or regulating elements for the temperature of the heating unit 21 or the air, which is heated by this heating unit and serves the purpose of bonding, are shown in the drawing.

The temperature signals of the temperature probe 43 are sent over a signal line 41 to the control and regulating unit 40, which consists of a computer. The control and regulating unit 40 controls the temperature of the heated air, which is blown out, by means of a control line 42, which correspondingly raises or lowers the temperature of the electric heating elements of the heating unit 21.

The temperature of the table 1 is measured behind the slit of the rolls 4, 5 by means of a temperature probe 45, whose signals are sent over a signal line 46 to the control and regulating unit 40. The temperature probe 45 measures in essence the temperature of the device so that the temperature of the hot air, blown out of the slit die 30, can be preset by the control and regulating unit.

Independently of the described control, the temperature of the hot air, blown out of the slit die 30, can also be set manually at the control and regulating unit, a feature that can be practical for presetting the temperature.

FIG. 4 shows a detail of a side view, as depicted in FIG. 1. However, the embodiment, depicted in FIG. 4, includes a heating coil, which is indicated by the serpentine line 50. This embodiment presents only as an example one possibility for tempering a cylinder.

1. Process for tempering plastic film, which is to be bonded and which exists preferably in the form of slips (8), on collapsed tubular pieces or workpieces (2) made of plastic film, for example valve slips on the raised bottom squares, or bottom cover sheets on the assembled bottoms of block bottom valve sacks,
whereby the tubular pieces or the workpieces are conveyed by means of a conveyor with a plate or a table (1) and fed into a slit between a counterpressure element, preferably a counterpressure roll (4) and a suction cylinder (6) and
whereby the plastic film to be bonded is fed and transferred by a conveying cylinder (7) to the suction cylinder (6), characterized in that the plastic film to be bonded is already tempered during transport in the roll slit.

2. Process, as claimed in claim 1, characterized in that at least one part of the devices that convey or store the film to be bonded is tempered so that there is direct heat transfer between the tempered devices and the plastic film to be bonded.

3. Process, as claimed in claim 2, characterized in that the devices that are to be tempered and that convey or store the film to be bonded are tempered or heated using one or more of the different processes:
by means of electric heating elements
by feeding pretempered liquid
by means of tempering elements
by means of heating cartridges

4. Process, as claimed in any one of the preceding claims, characterized in that the temperature of the plastic film and the tubular pieces or workpieces can be further adjusted by blowing air into the area of the roll slit between the counterpressure roller (4) and the suction cylinder (6).

5. Process, as claimed in any one of the preceding claims, characterized in that only the conveying cylinder (7) can be tempered by the conveying devices.

6. Process, as claimed in any one of the preceding claims, characterized in that only the conveying cylinder (7) and the suction cylinder (5) can be tempered by the conveying devices.

7. Process, as claimed in any one of the preceding claims, characterized in that the tubular pieces or workpieces are already tempered before reaching the roll slit.

8. Process, as claimed in any one of the preceding claims, characterized in that the temperature of the cemented areas of the workpiece is measured as the actual value immediately after bonding, and the temperature of the temperable conveying devices and optionally the air blown into the roll slit and
optionally the tubular pieces and workpieces is determined and set as the desired value.

9. Device for bonding plastic film, preferably slips (8) made of plastic film on collapsed tubular pieces or workpieces made of plastic film, for example valve slips on the raised bottom squares, or bottom cover sheets on the assembled bottoms of the block bottom valve sacks, comprising a frame with a plate or a table (1), by means of which the tubular sacks or valve sacks are conveyed,
a pair of rolls, which are arranged on one end or in a gap of the table and which comprise a counterpressure roll (4) and a vacuum roll (5), whose roll slit is largely aligned with the surface of the table,
a conveying cylinder (7), which transfers the plastic film to be bonded to the suction cylinder, characterized in that the conveying cylinder is equipped with devices for tempering it.
